(19) United States
(12) Patent Application Publication
(10) Pub. No.: US 2025/0327553 A1
(43) Pub. Date: Oct. 23, 2025

(54) LIGHTING DEVICE HAVING A LIGHTING MODULE ARRANGED IN FRONT OF AN ILLUMINATION MODULE

(71) Applicant: VALEO VISION, Bobigny (FR)

(72) Inventors: Sidahmed BEDDAR, Bobigny (FR); Eduardo ALVEAR, Bobigny (FR); Hafid EL-IDRISSI, Bobigny (FR)

(73) Assignee: VALEO VISION, Bobigny (FR)

(21) Appl. No.: 18/867,237

(22) PCT Filed: May 26, 2023
(86) PCT No.: PCT/EP2023/064249

§ 371 Date: Nov. 19, 2024

(30) Foreign Application Priority Data
May 31, 2022 (FR) FR2205246
Dec. 22, 2022 (FR) FR2214233

(51) Int. Cl. F21S 41/20; B60Q 1/14; F21W 102/13; F21Y 115/20

(52) U.S. Cl. CPC F21S 41/285; B60Q 1/1415; F21W 2102/13; F21Y 2115/20

(57) ABSTRACT

The invention relates to a luminous device for an automotive vehicle. The luminous device includes at least one lighting module capable of projecting light rays in order to perform a lighting function, a luminous module, and a control element. The luminous module is at least partially transparent and is arranged so that light rays emitted by the lighting module pass through it, and the control element is capable of activating the luminous module when the at least one lighting module is deactivated.

### TECHNICAL FIELD

The present invention relates to the field of luminous devices comprising one or more lighting modules, in particular for automotive vehicle headlamps. The invention applies in particular, but not exclusively, to the external appearance of such headlamps, in particular when the vehicle is driven during the day.

### BACKGROUND OF THE INVENTION

The Luminous devices such as headlamps generally have a plurality of luminous functions performed by one or more modules. The following luminous functions are known in particular:
a low beam (LB) lighting function;
a high beam (HB) lighting function, which may be performed by the same lighting module as the one responsible for the LB function, or by a different module;
a daytime signaling function, also referred to as daytime running light (DRL), generally performed by a different luminous module from the LB/HB module;
a position light (PL) signaling function, which may be performed by the luminous module which performs the DRL function, or by another luminous module.

The external appearance of the luminous device, which depends on the respective arrangement of the luminous modules, their number and their respective shapes, is referred to as the “signature”. The signature is particularly visible when all the modules of the luminous device are activated.

Such a signature may be perceived differently when driving at night and when driving during the day. This is because at night, the module(s) that perform the lighting functions such as LB and HB are visible to an outside observer. A complete signature is thus obtained.

However, during the day, these lighting functions are generally not activated, which results in one or more dark areas in the signature of the luminous device. The signature of the luminous device is incomplete and different from the night signature for an observer located outside the vehicle.

There is therefore a need to harmonize the signature of luminous devices for automotive vehicles between driving during the day and driving at night, while providing a solution that is robust, easy to incorporate and low-cost.

### SUMMARY OF THE INVENTION

The present invention improves the situation.

To this end, a first aspect of the invention relates to a luminous device for an automotive vehicle, comprising at least one lighting module capable of projecting light rays to perform a lighting function, a luminous module, and a control element. The luminous module is at least partially transparent and is arranged so that light rays emitted by the lighting module pass through it, and the control element is capable of activating the luminous module when the at least one lighting module is deactivated.

The use of a luminous module which is activated when the at least one lighting module is deactivated makes it possible to harmonize the signature of the luminous device between situations of driving at night and driving during the day. In addition, as the luminous module is at least partially transparent, it makes it possible for the lighting function to be performed by the lighting module when the luminous module is not activated.

According to non-limiting embodiments, said at least one lighting module may be capable of performing a low beam lighting function and/or a high beam lighting function.

Such functions are usually deactivated during the day, and the modules that perform them are precisely capable of creating dark areas in the signature of the luminous device.

When a single lighting module is capable of performing both functions, the footprint associated with the performance of these functions is limited within the luminous device.

According to non-limiting embodiments, the luminous device may comprise a first lighting module capable of performing a low beam lighting function and a second lighting module capable of performing a high beam lighting function, the luminous module being arranged so that the light rays from the first lighting module and/or the second lighting module pass through it.

The luminous device may thus comprise two lighting modules, and the luminous module may be capable of shielding the dark areas associated with at least one of these two lighting modules.

A single luminous module may also be shared by two lighting modules, which limits the costs and footprint of the luminous device according to the invention.

According to non-limiting embodiments, the luminous module may be capable of emitting light rays in at least one luminous pattern, the luminous module being arranged so that said at least one luminous pattern is facing an optical surface of the at least one lighting module.

The luminous pattern may thus overlap the optical surface of the at least one lighting module. The luminous pattern may in particular be the same shape as the optical surface of the at least one lighting module, which makes it possible to harmonize the signature of the luminous device with a high degree of precision.

According to non-limiting embodiments, the luminous module may be arranged inside a lens of an optical system of the lighting module.

The luminous module is thus mechanically protected and is not exposed to the outside of the luminous device.

According to non-limiting embodiments, the luminous module may be arranged on an outer lens of the luminous device.

The assembly of the luminous module is thus facilitated.

According to a first non-limiting embodiment, the luminous module may comprise:
a light guide comprising an at least partially transparent guide sheet, the guide sheet being capable of receiving light rays through at least one light injection edge of said guide sheet and reflecting the light rays in a direction locally substantially normal to a surface of the guide sheet in at least one luminous pattern, the light guide further comprising at least one light injection element capable of receiving light and distributing the light in the guide sheet;
at least one light source capable of injecting light into said at least one light injection element.

The control element may be capable of activating said at least one light source when the lighting module is deactivated.

The luminous module is thus of the type having a guide sheet, for example a flexible guide sheet, which is low-cost, easy to manufacture, and easy to incorporate. In addition, such a solution is little affected by environmental conditions such as humidity and temperature.

“Flexible” is given to mean that the guide sheet is capable of being curved without being damaged. Such a guide sheet may thus be placed on a non-flat substrate and adopt the shape thereof without being damaged. In particular, when the luminous module comprising the flexible guide sheet is placed facing a lighting module, the flexible guide sheet may be curved according to the curvature of an optical projection surface of the lighting module. In particular, the flexible guide sheet may be arranged so that it is convex, with a radius of curvature facing toward the inside of the automotive vehicle when the luminous device is mounted in or on said automotive vehicle.

Additionally, according to the first non-limiting embodiment, the luminous device may comprise a first lighting module capable of performing a low beam lighting function and a second lighting module capable of performing a high beam lighting function, and the luminous module may comprise a single light guide, a first pattern being etched into a first part of the guide sheet of the single light guide and a second pattern being etched into a second part of the guide sheet of the single light guide, the first pattern being arranged facing a first optical projection surface of the first lighting module and the second pattern being arranged facing a second optical projection surface of the second lighting module.

The footprint and the cost associated with the luminous module are thus reduced, with a single injection element and one source to illuminate two patterns facing two different lighting modules.

Additionally, the single light guide may comprise a guide sheet, a first light injection element and a second light injection element, and the first light injection element may be arranged so as to inject light into a first section of the light injection edge of the guide sheet and the second light injection element may be arranged so as to inject light into a second section of the light injection edge of the guide sheet, the first part of the guide sheet being situated facing the first section of the light injection edge and the second part of the guide sheet being situated facing the second section of the light injection edge.

Such embodiments advantageously make it possible to selectively control the illumination of the first and second luminous areas. It is thus possible to illuminate only one or other of the patterns, in particular when only one of the lighting modules is deactivated.

According to second and third non-limiting embodiments, the luminous module may comprise an at least partially transparent substrate, an emission layer comprising an electroluminescent material contained between a first electrode and a second electrode, the first electrode being contained between the transparent substrate and the emission layer, and the control element may be capable of controlling a voltage source capable of applying a voltage between the first electrode and the second electrode, so that the emission layer emits light rays toward the outside of the luminous module.

The luminous module may thus be an at least partially transparent display that is only activated when the lighting module is deactivated. The footprint associated with the luminous device is thus reduced compared to a solution having a light guide.

Additionally, according to the second and third non-limiting embodiments, the first electrode, the second electrode, and the emission layer may each have a thickness of less than 10 micrometers, in particular less than one micrometer.

Such thicknesses allow a high degree of transparency of the luminous module, which makes it possible for the lighting module to perform the lighting function, while reducing the footprint associated with the luminous device. Such thicknesses may in particular be obtained using an atomic layer deposition method.

According to non-limiting embodiments, the luminous module may further comprise a first transport layer and a second transport layer, the first transport layer being contained between the emission layer and the first electrode and the second transport layer being contained between the emission layer and the second electrode.

It is thus possible to facilitate the recombination of electrons and holes in the emission layer so as to emit light rays to the outside of the luminous module.

In the second and third non-limiting embodiments, the luminous module may further comprise an at least partially transparent protective layer, for example made from glass, the second electrode being contained between the protective layer and the emission layer.

The luminous module is thus mechanically protected.

According to the second non-limiting embodiment, the electroluminescent material may be an inorganic electroluminescent material, in particular an inorganic electroluminescent material comprising manganese-doped zinc sulfide.

Such a material has better tolerance to temperature variations than an organic material.

Manganese-doped zinc sulfide makes it possible to obtain yellow or green light, and operates in a temperature range of between −100° C. and +105° C.

According to the third non-limiting embodiment, the electroluminescent material may be an organic electroluminescent material, in particular an organic electroluminescent polymer.

The luminous module may thus be an organic light emitting diode (OLED), or a pixelated OLED display.

According to non-limiting embodiments, the luminous device may further comprise a signaling module capable of performing a daytime running light function, wherein the control unit is capable of controlling the signaling module and, upon activation of the daytime running light function, the control unit may be configured to activate the luminous module.

As such a signaling function is activated during the day, the luminous module is activated when the lighting functions are deactivated. This makes it easier to harmonize the signature of the luminous device.

### BRIEF DESCRIPTION OF DRAWINGS

Other features and advantages of the invention will become apparent on examining the following detailed description and the appended drawings, in which:

FIG. 1a depicts a light guide of a luminous module of a luminous device for an automotive vehicle, according to a first non-limiting embodiment of the invention;

FIG. 1b depicts a front view of a luminous module of a luminous device for an automotive vehicle, according to the first non-limiting embodiment of the invention;

FIG. 1c depicts a three-dimensional view of a luminous module of a luminous device for an automotive vehicle, according to the first non-limiting embodiment of the invention;

FIG. 2 depicts a luminous module of a luminous device for an automotive vehicle, according to second and third non-limiting embodiments of the invention; [FIG. 1] illustrates part of a luminous module according to the invention;

FIG. 3 depicts a luminous device for an automotive vehicle, according to non-limiting embodiments of the invention;

FIG. 4 depicts a first example of a luminous module of a luminous device for an automotive vehicle, according to the first non-limiting embodiment of the invention;

FIG. 5 depicts a second example of a luminous module of a luminous device for an automotive vehicle, according to the first non-limiting embodiment of the invention; and

FIG. 6 depicts a third example of a luminous module of a luminous device for an automotive vehicle, according to the first non-limiting embodiment of the invention.

### DETAILED DESCRIPTION OF THE INVENTION

The description concentrates on the features that differentiate the luminous device and the luminous module from those known in the prior art.

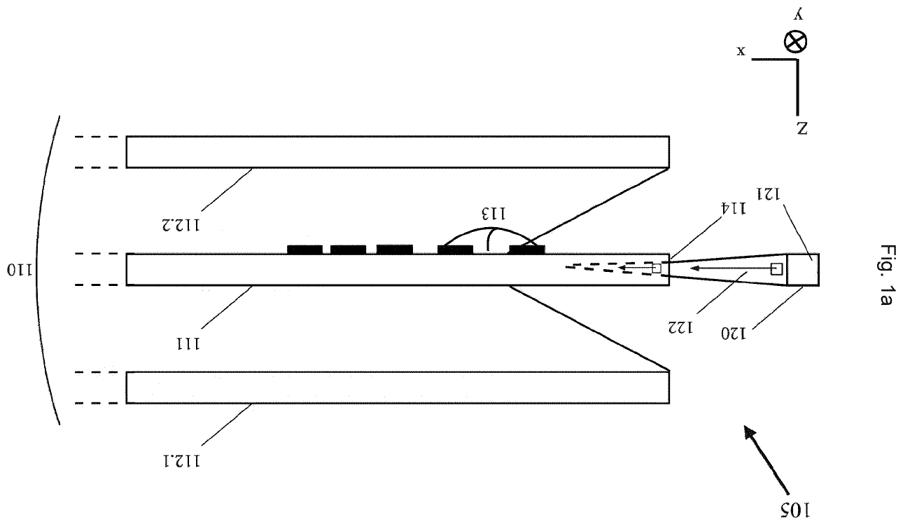

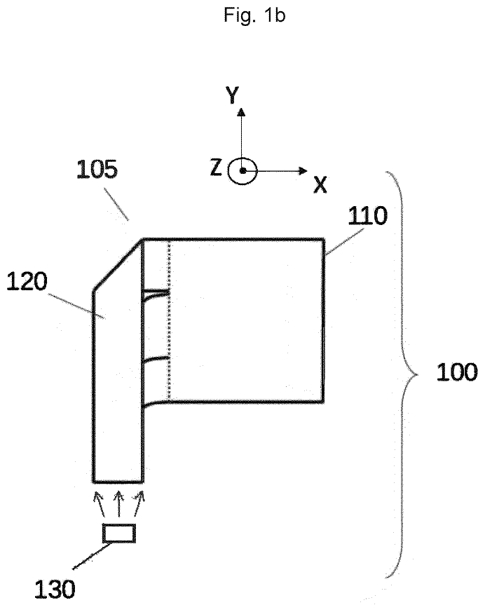

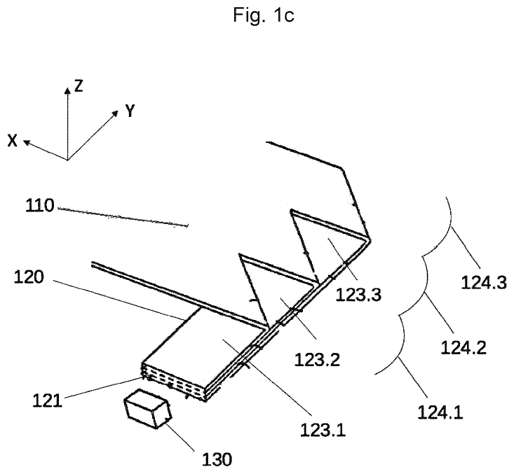

FIG. 1a shows a light guide 105 of a luminous module of a luminous device for an automotive vehicle, according to a first non-limiting embodiment of the invention.

The light guide 105 comprises a guide sheet 110 capable of receiving light rays through a light injection edge 114 and reflecting the light rays in a direction Z substantially normal to a surface of the guide sheet which thus extends in a plane X-Y in FIG. 1a.

Guide sheet is given to mean an optical guide element one of the dimensions of which is much smaller than the other two dimensions in space, for example smaller by one or more orders of magnitude. As shown in FIG. 1a, in this case it is a guide sheet the thickness of which along the axis Z is at least two orders of magnitude smaller than its dimensions in the plane X-Y in which the guide sheet 110 extends. Such a guide sheet may advantageously be flexible, which makes it easier to incorporate into a luminous device. The description below relates to a flexible guide sheet 110 by way of illustration.

The guide sheet 110 may comprise at its core a film 111, which may advantageously be flexible, comprising at least one light injection edge 114, being capable of guiding the light rays in an overall direction X, and comprising a set of microstructures 113 capable of reflecting the light rays guided in the film 111 outside the guide sheet 110, in particular in one or more directions substantially along the axis Z.

The film 111 may be a polycarbonate (PC), polymethyl methacrylate (PMMA), thermoplastic polyurethane (TPU), or polyethylene terephthalate (PET) substrate film. The film 111 may have a thickness, that is a dimension along the axis Z, of between 12 and 1,000 micrometers. More specifically, the thickness of the film 111 may be between 50 and 1,000 micrometers, for example between 200 and 500 micrometers. As a variant, it is the guide sheet 110 which has a thickness of between 200 and 1,000 micrometers.

The aforementioned materials, associated with a small thickness as described above, make it possible to obtain a flexible film 111. Other materials may be envisaged for the composition of the flexible film 111. However, it is preferable according to the invention to envisage deformable, transparent materials.

A thin coating of microstructures 113 may be applied to one of the faces of the film 111, or be incorporated into the film 111. The microstructure coating 113 may in particular have a thickness along the axis Z of less than 20 micrometers.

Such microstructures 113 may take the general form of a boss, on which the light rays are reflected in a direction substantially along the axis Z. Such microstructures 113 may be adapted so that the light rays exiting the film 111 form a luminous pattern. To this end, the microstructures 113 may be etched by ultraviolet printing, so as to reflect the light rays injected into the injection edge 114 through the surface of the film 111 in the desired pattern. For example, the microstructures may be distributed to form a luminous pattern of a given shape with uniform light over the whole luminous pattern thus formed.

Microstructures 113 is given to mean structures, or irregularities of the film 111, with dimensions of less than a few micrometers. Microstructures thus also include nanometric structures. Such sizes of microstructures 113 make it possible to ensure high transparency of the film 111. In particular, a transparency of the order of 97% may be obtained in practice by the use of microstructures 113. The luminous module according to the first embodiment of the invention, comprising the light guide 105, is at least partially transparent, that is, it allows through at least some of the light rays that reach the guide sheet. For example, the luminous module may have a transparency greater than 50%, preferably greater than 70%, or even greater than 90%.

Advantageously, the microstructures 113 may be distributed along the axis X so that a linear density of microstructures 113 is proportional to the distance from the light injection edge 114 through which the light rays injected by an injection element 120 of the light guide 105 are received.

In other words, the further the microstructures 113 are from the light injection edge 114, the more densely they are grouped together. Such a distribution advantageously makes it possible to ensure uniform distribution along the axis X of the luminous intensity of the pattern emitted by the guide sheet 110.

The guide sheet 110 may further comprise one or two optional protective layers 112.1 and 112.2, which make it possible to mechanically protect the film 111. In addition, at least one of the protective layers 112.1 and 112.2 may comprise an anti-UV treatment, making it possible to protect the film 111 against UV rays, once the microstructures 113 have been etched. Without such UV protection, the pattern projected by the guide sheet 110 is likely to deteriorate over time, in particular when exposed to sunlight.

The film 111 and the protective layers 112.1 and 112.2 are shown spaced apart in FIG. 1a, purely for illustrative purposes. It will be understood, however, that the protective layers 112.1 and 112.2 may be attached to the film 111, in particular by lamination.

Since the guide sheet 110 may be flexible, it is not necessarily contained in a plane but may be curved, depending on the position in which it is placed and the mechanical constraints applied to it.

The light guide 105 illustrated in FIG. 1a also comprises a light injection element 120, comprising an assembly of injection sheets described with reference to FIGS. 1b and 1c, the light injection element 120 being capable of distributing the light in the guide sheet 110 at different positions on the axis Y, along the light injection edge 114. The light is injected, at each position along the axis Y, in a direction substantially parallel to the axis X.

The light injection element 120 comprises an input surface 121 having a rectangular or square cross-section in FIG. 1a. However, the light injection element 120 may have an input surface having a differently shaped cross-section.

In FIG. 1a, the light injection element 120 is shown with an output surface 122 extending in the direction Y and placed facing the light injection edge 114. It will be understood on reading the description of FIGS. 1b and 1c that the output surface 122 and the light injection edge 114 are preferably coincident, the film 111 and the assembly of injection sheets forming a single part.

The input surface 121 is capable of receiving light rays from a light source outside the light guide 105 and not shown in FIG. 1a. The light injection element 120 is capable of guiding the light longitudinally along the axis Y, distributing it on the output surface 122. The distribution of light by the output surface 122 will be understood more clearly from the description of FIGS. 1b and 1c.

FIG. 1b shows a luminous module 100 of a luminous device according to the first embodiment of the invention. The luminous module 100 comprises a light guide 105 having an injection element 120 and a guide sheet 110, and a light source 130.

With reference to FIG. 1c, the injection element 120 may comprise a plurality of injection sheets 123.1, 123.2, and 123.3, capable of receiving light from the source 130 through the input surface 121 and guiding the light to assemblies 124.1, 124.2, and 124.3 in different positions along the Y axis. As shown in FIGS. 1b and 1c, the injection sheets 123.1, 123.2, and 123.3 may be made from the same material and have the same thickness as the film 111 of the guide sheet 110. The light guide 105 may thus be obtained using a roll to roll (R2R) manufacturing method, during which the film 111 and the injection sheets 123.1, 123.2, and 123.3 are obtained from the same roll of film, which may be flexible, the injection sheets 123.1, 123.2, and 123.3 being cut at different positions along the axis Y, in a cutting direction substantially parallel to the direction X. The injection sheets 123.1, 123.2, and 123.3 thus obtained are preferably flexible and may be folded as shown in FIG. 1c. Each injection sheet 123.1, 123.2, and 123.3 may be cut along respective lengths so that once it is folded, its end forms, with the ends of the other injection sheets, the injection surface 121, as depicted in FIG. 1c.

An injection element 120 having three injection sheets 123.1, 123.2, and 123.3 is shown in FIGS. 1b and 1c, purely by way of illustration. The injection element 120 may however comprise any assembly of injection sheets comprising at least two injection sheets.

No restriction is imposed on the light source 130. The light source 130 may be capable of generating light in a wavelength range. Such a range may be centered around a visible color, in order to generate colored light, for example blue, red, or green. As a variant, the light source 130 may emit light rays across the entire range of wavelengths visible to the human eye, in such a way as to generate white light. A very narrow wavelength range may be produced by a laser type light source 130.

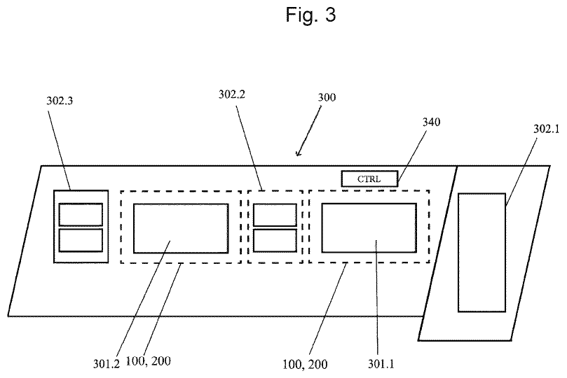

The light source 130 may be controlled by a control element, not shown in FIGS. 1b and 1c but described hereinafter with reference to FIGS. 3 to 6.

As a variant, the light source 130 is not arranged directly facing the input surface 121 of the injection element 120, but the luminous module 100 according to the first embodiment further comprises an optical fiber placed between the source 130 and the injection element 120, which makes it possible to move the source 130 away from light guide 105.

The injection element 120 disclosed thus makes it possible to inject light at different longitudinal positions along the axis Y on the light injection edge 114. Each longitudinal position on the injection edge 114 may correspond to a guide line of the film 111, capable of guiding the light on the axis X along such a guide line.

Such an association of a light guide 105 comprising a guide sheet 110 and an injection element 120, with a source 130, thus makes it possible to display a pattern by emitting light mainly along the direction Z, through an at least partially transparent surface that has good surface uniformity. In addition, when the guide sheet 110 is flexible, it is easier to incorporate the luminous module 100 into an apparatus.

In practice, such a luminous module 100 according to the first embodiment makes it possible to emit light with a luminance of between 100 and 1,000 candelas per square meter, with a light extraction efficiency that may range between 25% and 80%.

Details about the structure and arrangement of elements 105, 110, 120 and 130 are described further in the international patent application published under number WO2011130715A2.

“Pattern” is given to mean any predefined spatial distribution of the luminous intensity emitted by the luminous module 100. In particular, reference is made here to a two-dimensional or one-dimensional pattern.

A pattern may thus comprise a uniform distribution of light over the luminous module as a whole. The pattern may also comprise a two-dimensional shape or symbol obtained by contrast between the luminous intensities of different positions in the plane X-Y of the guide sheet 110. The pattern may also comprise a plurality of shapes or symbols.

A luminous module of a luminous device for a vehicle according to the first embodiment of the invention comprises:
a light guide 105 comprising a guide sheet, such as the guide sheet 110 depicted in FIG. 1a, capable of reflecting light in at least one luminous pattern, and at least one light injection element such as the injection element 120 described with reference to FIGS. 1a, 1b, and 1c; and
at least one light source, such as the light source 130 described above with reference to FIGS. 1b and 1c, capable of injecting light into said at least one injection element.

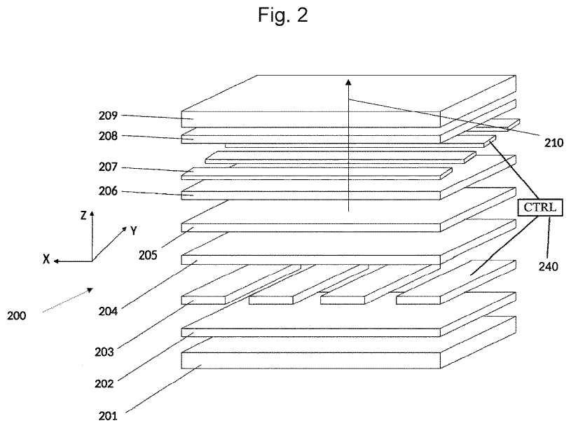

FIG. 2 depicts a luminous module 200 of a luminous device for a vehicle, according to second and third non-limiting embodiments of the invention.

The luminous module 200, unlike the luminous module 100 having a light guide, is a display activated by applying a potential difference to an emission layer made from an electroluminescent material.

The luminous module 200 is also at least partially transparent, due in particular to the properties of the layers forming it, which are described below.

The second and third embodiments mainly differ with respect to the electroluminescent emission layer used.

According to the second embodiment, the emission layer is formed using an electroluminescent inorganic phosphor, while in the third embodiment the emission layer is formed using an electroluminescent organic material.

In the second and third embodiments, the luminous module 200 comprises:
a substrate 201 made from an at least partially transparent material, for example glass. Such a material may be selected because it allows a high degree of transparency;
a first electrode 203, for example a cathode, connected to a voltage source controlled by a control element 240;
a hole transport layer (HTL) 204 in contact with the cathode 203;
an emission layer 205 comprising an electroluminescent material;
an electron transport layer (ETL) 206 in contact with a second electrode 207;
a second electrode 207, in particular an anode 207. It should be noted that the anode and the cathode may be inverted in the stack of layers, connected to the voltage source controlled by the control element 240;
a protective layer 209 made from an at least partially transparent material, preferably glass. Such a material may be selected because it allows a high degree of transparency.

The electron transport layer 206 may comprise a material doped with electrons, that is, having extra electrons, promoting the transfer of electrons in the emission layer 205. In a symmetrical manner, the hole transport layer 206 may comprise a material having a lack of electrons, or doped with holes, thus promoting the creation of holes in the emission layer and thus promoting recombination in the emission layer 205 leading to the emission of photons. The holes and the electrons combine in the emission layer, leading to the emission of photons the properties of which depend in particular on the electroluminescent material of the emission layer. Such a principle is well known and is not described in more detail in the present description.

The emission layer 205 may thus emit photons when a voltage greater than a voltage threshold is applied to the electrodes 203 and 207.

The luminous module 200 according to the second and third embodiments may also optionally comprise:
a layer forming an ion barrier 202 between the substrate 201 and the first electrode 203;
a layer of optical index-matching material 208, contained between the protective layer 209 and the second electrode 207, capable of allowing the light rays from the emission layer 205 to pass through the protective layer 209. In particular, the light rays emitted by the emission layer 205 may be bent toward a main direction of emission that is preferably along the axis Z, and therefore perpendicular to the surface of the protective layer 209.

The properties and thickness of the optical index-matching material 208 may depend on the optical index of the protective layer 209.

In FIG. 2, the first electrode 203 comprises a plurality of conductive elements arranged at different positions along the axis X and extending longitudinally along the axis Y. Likewise, the second electrode 207 may comprise a plurality of conductive elements arranged at different positions along the axis Y and extending longitudinally along the axis X. The control element 240 may thus apply a voltage to specific positions on the emission layer, by selecting an element of the first electrode to select a position on the axis X and by selecting an element of the second electrode 207 to select a position on the axis Y. It is thus possible to control the luminous module in a pixelated manner. The luminous module 200 may thus form a pixelated display. However, such an embodiment is optional.

According to the invention, the first and second electrodes 203 and 207 may each comprise a single planar element extending continuously at different positions on the axes X and Y, so as to apply a voltage to a set of positions on the axes X and Y on the emission layer, these positions forming a luminous pattern. Such a luminous pattern may have a regular shape such as a square, a rectangle, a diamond or other shape, or may have a more complex shape, comprising curves for example. In order to produce such a pattern, the emission layer 205 may have a given shape in the plane X-Y corresponding to the desired luminous pattern. At certain locations on the luminous module, the emission layer 205 may thus be absent between the layers 204 and 206, and the application of an electrical voltage to these locations thus does not produce any light rays, making it possible to produce luminous patterns.

The at least partial transparency of the luminous module 200 is made possible:
by the material used for the cover layer 209 and the substrate layer 201, which are preferably made from glass. The layers 201 to 209 are not thus constrained in their thickness along the axis Z. The thickness of each layer 201 and 209 is however preferably less than 2 mm;
by the respective thicknesses of the electrodes 203 and 207, and of the layers 202, 204 to 206, and 208, which are less than 10 micrometers, preferably less than one micrometer.

The elements common to the second and third embodiments are described above.

In the second embodiment, the emission layer 205 comprises an inorganic electroluminescent material, for example an inorganic phosphor. For example, the emission layer 205 may comprise zinc sulfide, denoted ZnS, doped with manganese, denoted ZnS:Mn. The ZnS:Mn material makes it possible to emit photons having a wavelength corresponding to a yellow or green color. Other inorganic electroluminescent materials may be envisaged according to the second embodiment. For example, the emission layer 205 may comprise indium-gallium nitride, InGaN, which comprises gallium nitride GaN and indium nitride, InN. The wavelength of the light emitted by such a material may vary from the ultraviolet domain to orange, as a function of an indium to gallium ratio. According to other examples, the emission layer 205 may comprise quantum dots based on cadmium selenide (CdSe), copper indium (CuIn), indium phosphide (InP) and/or lead selenide (PbSe). The color of the light emitted may vary, in particular in all of the wavelengths of the visible domain, as a function of the size of the quantum dot. By way of illustration, a six nanometer quantum dot is capable of emitting red light rays, while a two nanometer quantum dot is capable of emitting blue light rays.

The electrodes 203 and 207 may be made from indium tin oxide (ITO). However, no restriction is imposed on the material of the electrodes 203 and 207.

Likewise, no restriction is imposed on the material of the transport layers 204 and 206, which may be made from antimony-doped tin oxide, also denoted ATO.

Preferably, some of the layers may be produced using a manufacturing method referred to as atomic layer deposition (ALD), which makes it possible to increase the transparency of the luminous module 200. In particular, such a manufacturing method may be used to produce the emission layer 205, but also optionally to produce the transport layers 204 and 206, and for the layer forming an ion barrier 202 and the optical index-matching layer 208.

According to such a manufacturing method, the material deposited does not form a continuous layer but is distributed in the plane X-Y according to a certain granularity, which increases the transparency of the layer and therefore of the luminous module 200.

It is thus possible to obtain high degrees of transparency of the luminous module 200, in particular greater than 60%, or even 70%, for example 80%.

The supply voltage used to activate the emission of photons in the emission layer may be several hundreds of volts, for example 195 V. The control element 240 may thus control the voltage source supplying the electrodes 203 and 207 to apply such a voltage or to apply no voltage. It is thus possible to activate and deactivate the luminous module 200 using the control element 240. The voltage is preferably applied at high frequency, in particular at a frequency of between 400 Hz and 1 kHz.

An operating power of the order of several watts is thus obtained, in particular between 3 W and 12 W, for a high luminance of the order of several hundred candelas per square meter, and up to 1300 cd/m2.

The luminous module according to the second embodiment also has the advantage of operating in a wide temperature range, in particular between −100° C. and +105° C.

As a variant, according to the third non-limiting embodiment of the invention, the emission layer 205 may comprise an organic electroluminescent material, for example an organic polymer.

The luminous module 200 then forms an organic light-emitting diode (OLED).

The layers 201 to 204 and 206 to 209 may be identical to those described with reference to the second embodiment.

According to a fourth non-limiting embodiment of the invention, the luminous module 200 according to the second and third embodiments further comprises a light guide 105 as disclosed in the first embodiment:
in place of the substrate 201, or arranged against the substrate 201; and/or
in place of the cover layer 209, or arranged against the cover layer 209.

It is thus possible to produce different luminous patterns, which may be activated selectively or cumulatively in order to overlap the luminous patterns.

According to one non-limiting embodiment, a light guide 105 may be arranged in place of the substrate 201, or against the substrate 201, the first light guide 105 comprising a first pattern etched into the guide sheet 110, and the emission layer 205 is distributed in a second pattern, different from the first pattern.

According to another non-limiting embodiment, a light guide 105 may be arranged in place of the cover layer 209, or against the cover layer 209, the first light guide 105 comprising a first pattern etched into the guide sheet 110, and the emission layer 205 is distributed in a second pattern, different from the first pattern.

According to yet another non-limiting embodiment, a first light guide 105 is arranged in place of the substrate 201, or against the substrate 201, the first light guide 105 comprising a first pattern etched into its guide sheet 110, the emission layer 205 is distributed in a second pattern, and a second light guide 105 is arranged in place of the cover layer 209, or against the cover layer 209, the second light guide 105 comprising a third pattern etched into its guide sheet, the first, second, and third patterns being different.

FIG. 3 depicts a luminous device 300 according to non-limiting embodiments of the invention.

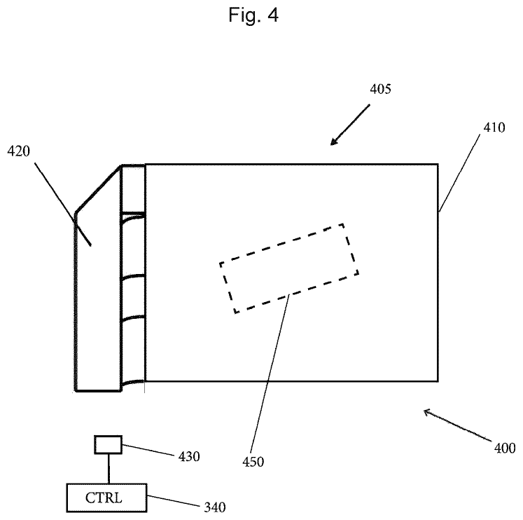

The luminous device 300 according to the invention comprises at least one luminous module according to the first, second, third, or fourth embodiment. Exemplary embodiments of the luminous module 100 according to the first embodiment will be described with reference to FIGS. 4, 5, and 6, which describe luminous modules 400, 500, and 600 respectively. The luminous module 100 according to the first embodiment may thus be a luminous module 400 according to a first example, a luminous module 500 according to a second example, or a luminous module 600 according to a third example. The luminous module 200 corresponds to the second and third embodiments. The fourth embodiment may combine the luminous module 200 according to the second and third embodiments, with one or more of the examples of luminous modules 400, 500, and 600 described below, arranged in place of the substrate 201, or arranged against the substrate 201, and/or arranged in place of the cover layer 209, or arranged against the cover layer 209.

The luminous module shown in FIG. 3 thus encompasses all of the embodiments and is denoted 100, 200.

As will become clear, the luminous device 300 may comprise a plurality of luminous modules 100, 200.

The luminous device 300 further comprises a lighting module 301.1 or 301.2 capable of projecting light rays toward the outside of the luminous device 300 in order to perform at least one lighting function. Such a lighting function may for example be a low beam (LB) function or a high beam (HB) function. As a variant, the at least one lighting module 301.1 or 301.2 is controllable, for example by a control element 340, and may be controlled to perform two different lighting functions, such as the LB and HB functions. No restriction is imposed on the technology associated with the lighting module. No restriction is imposed in particular on the light source of the at least one lighting module 301.1 or 301.2, which may be a source comprising a luminous element or a plurality of luminous elements, such as one or more LEDs. The light source of the lighting module may be an array source, comprising an array of DMDs, an array of LEDs, or any other array source.

The luminous device 300 may optionally comprise one or more signaling modules 302.1, 302.2, and 302.3, capable of emitting light rays toward the outside of the luminous device in order to perform a signaling function. The signaling module may, for example, be capable of performing a position light PL function or a daytime running light DRL function. In addition, the at least one signaling module 302.1, 302.2, and/or 302.3 may be capable of performing both the position light PL and daytime running light DRL functions, with only the luminous intensity emitted by the signaling module being variable between the two functions. Such a variation in luminous intensity may be obtained by activating/deactivating luminous sources of the signaling module, or by supplying power to the luminous source(s) in pulse width modulation, by varying the duty cycle.

The luminous device 300 for an automotive vehicle is preferably an automotive vehicle headlamp, for example an automotive vehicle front headlamp.

No restriction is imposed on the number of lighting modules, luminous modules 100, 200 and signaling modules that the luminous device 300 comprises, nor on their respective shapes and arrangements, which make up the signature of the luminous device 300. The luminous device 300 according to the invention comprises:
at least one lighting module 301.1 or 301.2;
at least one luminous module 100, 200 as described above;
at least one control element 340;
optionally, at least one signaling module.

According to the invention, the luminous module 100, 200 is at least partially transparent as described above and is arranged so that light rays emitted by the at least one lighting module 301.1 or 301.2 pass through it. Preferably, the luminous module 100, 200 is capable of emitting light in at least one given pattern, the given pattern having the same shape as an optical projection system of the at least one lighting module 301.1 or 301.2.

By activating the luminous module 100, 200 when the at least one lighting module 301.1 or 301.2 is deactivated, it is possible to harmonize the appearance of the luminous device by day and by night, in particular in order to harmonize a signature of the luminous device, as will be understood from reading the description below. The control element 340 may thus activate the luminous module 100, 200 when the at least one lighting module 301.1 or 301.2 facing which it is placed is deactivated.

The luminous module 100, 200 may be arranged inside a lens of an optical system of the at least one lighting module 301.1 or 301.2.

According to non-limiting embodiments, the luminous device 300 comprises a housing and an outer lens, which forms a lens for closing the housing, the at least one lighting module being positioned inside the inner volume created by the housing and the outer lens so that at least some of the light rays that it projects pass through the outer lens.

The luminous module 100, 200 may be arranged on one of the faces of the outer lens of the luminous device facing the optical system of the at least one lighting module 301.1 or 301.2. The luminous module 100, 200 may advantageously be arranged on the inner face of the outer lens, which makes it possible to protect the luminous module 100, 200 against attack from the external environment. The luminous module 100, 200 may also be arranged on the outer face of the outer lens, in particular when the structure of the luminous module 100, 200 makes it possible to withstand the aforementioned attack.

In the particular example shown in FIG. 3, the luminous device 300 comprises:
a first lighting module 301.1 and a second lighting module 301.2. For example, the first lighting module 301.1 may perform a low beam LB lighting function while the second lighting module 301.2 may perform a high beam HB lighting function;
a first signaling module 302.1, in two parts, upper and lower, a second signaling module 302.2, in two parts, upper and lower, and a third signaling module 302.3, in two parts, upper and lower. Each signaling module 302.1, 302.2, or 302.3 is capable of emitting light rays toward the outside of the luminous device in order to perform a signaling function. Each signaling module may perform its own signaling function, or as a variant, the signaling modules 302.1, 302.2, and 302.3 may perform the same signaling function(s), and thus be controlled together, for example by the control element 340;
a luminous module 100, 200 covering the two signaling modules 301.1 and 301.2, capable of displaying a first luminous pattern facing the first lighting module 301.1 and a second luminous pattern facing the second lighting module 301.2. As a variant, the luminous device comprises two luminous modules 100, 200, a first luminous module 100, 200 capable of being passed through by light rays from the first lighting module 301.1, and a second luminous module 100, 200 capable of being passed through by light rays from the second lighting module 301.2.

The control element 340 may be capable of controlling the activation and deactivation of all the modules, in other words the lighting module(s), the luminous module(s), and the optional signaling module(s). In this case, the control element incorporates the functions of the control element 240 described above according to the second and third embodiments. The control element 340 may control the activation or deactivation of each module as a function of control signals, received for example by a central control module of the automotive vehicle, such as an electronic control unit (ECU).

The control element 340 may comprise a processor configured for one-way or two-way communication, via one or more buses or via a wired connection, with a memory such as a random access memory (RAM) or a read only memory (ROM) or any other type of memory (flash, EEPROM, etc.). As a variant, the memory comprises a plurality of memories of the aforementioned types. Preferably, the memory is non-volatile memory. The processor is capable of executing instructions, stored in the memory, and controlling the modules of the luminous device 300 as a function of control signals. Alternatively, the processor may be replaced by a microcontroller designed and configured to implement control of the modules as a function of the control signals received.

As a variant, each module of the luminous, lighting and signaling modules comprises a dedicated control element.

According to the invention, the control element 340 is capable of activating the luminous module(s) 100, 200 facing a lighting module that is deactivated. The signature of the luminous device 100, which is made up of the shapes of the signaling and lighting modules, and by the respective arrangement thereof, is thus harmonized whether or not the lighting modules are activated.

Thus, an outside observer does not see a dark area in the region of the lighting module when it is deactivated, as is generally the case during the day. The invention thus makes it possible to harmonize the signature of the luminous device 300.

According to the second, third, and fourth embodiments, at least one luminous module 200 is thus capable of being passed through by the light rays from the lighting module 301.1 and/or the lighting module 301.2. When the luminous device 300 comprises a single luminous module 200, the emission layer 205 may form a first pattern arranged facing the lighting module 301.1 and a second pattern arranged facing the lighting module 301.2.

When the luminous device 300 comprises two luminous modules 200, a first luminous module 200 comprises an emission layer 205 forming a first luminous pattern arranged facing the first lighting module 301.1 and a second luminous module 200 comprises an emission layer 205 forming a second luminous pattern arranged facing the second lighting module 301.2.

When the lighting modules have optical surfaces of different shapes, the luminous patterns of the luminous module(s) 200 vary so that they are identical to the respective optical surfaces of the lighting modules that they cover. This makes it possible to harmonize complex signatures between the periods of day and night.

Several exemplary embodiments are also possible with at least one luminous module 100 according to the first embodiment. These examples are described below with reference to FIGS. 4, 5, and 6.

FIG. 4 shows a first example of a luminous module 400 of a luminous device according to a first embodiment of the invention.

The luminous module 400 comprises a light guide 405 comprising a guide sheet 410 and an injection element 420, and a light source 430, similar to the light guide 105 and the light source 130 of the luminous module 100 described above.

The guide sheet 410 is etched so that it reflects the light rays injected by the injection element 420 in a luminous pattern 450, following the activation of the light source 430, by the control element 340.

The pattern 450 is arranged facing an optical projection surface of a lighting module. The pattern 450 may also be shaped to overlap with the optical projection surface of the lighting module. The pattern 450 may thus have the same shape as a projection, in the plane of the guide sheet, of the optical projection surface of the lighting module.

This makes it possible to illuminate the pattern 450 by activating the source 430, when the lighting module, on which the luminous module 400 is placed, is deactivated. Thus, an outside observer does not see a dark area in the region of the lighting module when it is deactivated, as is the case during the day. The invention thus makes it possible to harmonize the signature of the luminous device comprising a luminous module 400 arranged on a lighting module.

The luminous module 400 may for example be used in the example of FIG. 3, being arranged facing the lighting module 301.1 or the lighting module 301.2. As a variant, the luminous device 300 comprises a first luminous module identical to the luminous module 400 arranged facing the first lighting module 301.1, and a second luminous module identical to the luminous module 400 arranged facing the second lighting module 301.2.

Thus, a plurality of luminous modules 400 according to the first embodiment may be advantageously used in a luminous device comprising a plurality of lighting modules. When the lighting modules have optical surfaces of different shapes, the patterns 450 of the luminous modules 400 may be identical to the respective optical surfaces of the lighting modules that they cover. This makes it possible to harmonize complex signatures between the periods of day and night.

Advantageously, the light source 430 is controlled by the control element 340 described above. The control element 340 may also control the lighting module facing which the luminous module 400 is placed. Thus, the control element 340 is capable of activating the light source 430 when it deactivates the lighting module.

In the example in FIG. 3, the control element 340 may activate a first luminous module 400 arranged facing the first lighting module 301.1, when the first lighting module 301.1 is deactivated, and the control element 340 may activate a second luminous module 400 arranged facing the second lighting module 301.2, when the second lighting module 301.1 is deactivated.

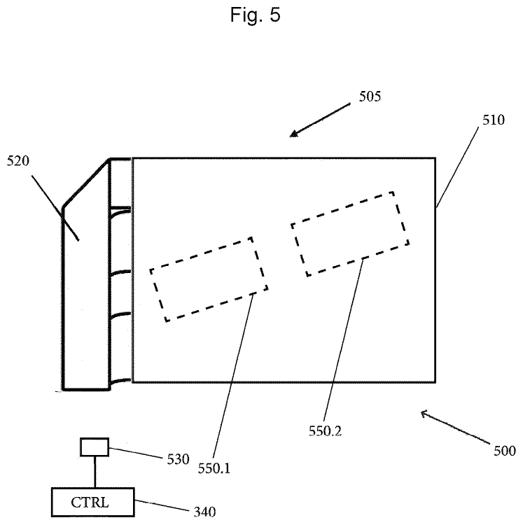

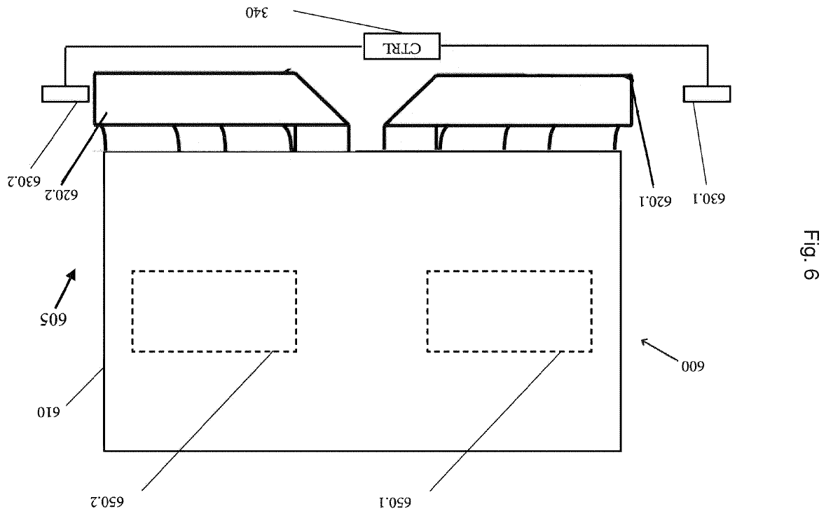

Alternatively, with reference to FIGS. 5 and 6, two variant embodiments of the first embodiment are disclosed in which a single luminous module 500 or 600 according to the first embodiment may be arranged facing at least two lighting modules of a luminous device.

FIG. 5 depicts a second example of a luminous module 500 of an luminous device according to the first embodiment of the invention, which is a variant of the luminous module 400 described above.

According to this variant, the luminous module 500 comprises a light guide 505 comprising a guide sheet 510 and an injection element 520, and a light source 530, similar to the light guide 105 and the light source 130 of the luminous module 100 described above with reference to FIGS. 1a to 1c.

The guide sheet 510 is etched so that it reflects the light rays injected by the injection element 520 in a first pattern 550.1 and in a second pattern 550.2, following the activation of the light source 530.

The first pattern 550.1 is arranged facing a first optical projection surface of a first lighting module and the second pattern 550.2 is arranged facing a second optical projection surface of a second lighting module. The first and second patterns 550.1 and 550.2 may also be shaped to overlap with the optical projection surfaces of the first and second lighting modules. The first and second patterns 550.1 and 550.2 may thus have the same shapes as projections in the plane of the guide sheet 510, of the optical projection surfaces of the lighting modules.

This makes it possible to illuminate the luminous patterns 550.1 and 550.2 by activating the source 530, when the first lighting module and/or the second lighting module, on which the luminous module 500 is placed, is/are deactivated. Thus, an outside observer does not see a dark area in the region of the lighting modules when at least one of the lighting modules is deactivated, as is generally the case during the day. The invention thus makes it possible to harmonize the signature of the luminous device comprising a luminous module 500 arranged on a plurality of lighting modules, using a single light guide 505 and a single light source 530. This reduces the footprint and costs.

The luminous module 500 may for example be used in the example in FIG. 3, being arranged facing the lighting modules 301.1 and 301.2.

A single luminous module 500 may thus be advantageously used in a luminous device comprising a plurality of lighting modules. When the lighting modules have optical surfaces of different shapes, the patterns 550.1 and 550.2 have different shapes so that they are identical to the respective optical surfaces of the lighting modules that they cover. This makes it possible to harmonize complex signatures between the periods of day and night.

Advantageously, the light source 530 is controlled by the control element 340 described above. The control element 340 may also control the lighting modules facing which the luminous module 500 is placed. The control element 340 is thus capable of activating the light source 530 when it deactivates at least one of the lighting modules of the luminous device.

In the example in FIG. 3, the control element 340 may activate the luminous module 500 arranged facing the first lighting module 301.1 and the second lighting module 301.2, when the first lighting module 301.1 is deactivated, when the second lighting module 301.1 is deactivated, or when the first and second lighting modules 301.1 and 301.2 are deactivated.

FIG. 6 depicts a luminous module 600 according to the first embodiment of the invention, which is a variant of the luminous modules 400 and 500 described above.

According to this variant, the luminous module 600 comprises a light guide 605 comprising a guide sheet 610, a first injection element 620.1 and a second injection element 620.2, and a first light source 630.1 and a second light source 630.2. These elements are similar to the light guide 105 and the light source 130 of the luminous module 100 according to the first embodiment described above with reference to FIGS. 1a to 1c.

The guide sheet 610 is etched in a first pattern 650.1 situated in a first part of the guide sheet 610, and a second pattern 650.2 situated in a second part of the guide sheet 610.

The first light source 630.1 is capable of injecting light into the first injection element 620.1 which is itself capable of injecting, or distributing, the light into the first part of the guide sheet so as to illuminate the first luminous pattern 650.1. To this end, the first injection element 620.1 is facing a first section of the light injection edge 114 of the guide sheet 610.

The second light source 630.2 is capable of injecting light into the second injection element 620.2 which is itself capable of injecting, or distributing, the light into the second part of the guide sheet 610 so as to illuminate the second pattern 650.2. To this end, the second injection element 620.2 is facing a second section of the injection edge 114 of the guide sheet 610, different from the first section.

In the luminous device, the first pattern 650.1 may be arranged facing a first optical projection surface of a first lighting module and the second pattern 650.2 may be arranged facing a second optical projection surface of a second lighting module. The first and second patterns 650.1 and 650.2 may further be shaped to overlap with the optical projection surfaces of the first and second lighting modules. The luminous patterns 650.1 and 650.2 may thus have the same shapes as projections, in the plane of the guide sheet 610, of the optical projection surfaces of the lighting modules.

This makes it possible to illuminate the patterns 650.1 and 650.2 by selective activation of the sources 630.1 and 630.2. When the first lighting module is deactivated, the first light source 630.1 may be activated. When the second lighting module is deactivated, the second light source 630.2 may be activated. The sources 630.1 and 630.2 may thus be controlled separately, for example by the control element 340.

As a variant, the control element 340 simultaneously activates the sources 630.1 and 630.2, and the first and second luminous patterns 650.1 and 650.2 are thus displayed when at least one of the first and second lighting modules is deactivated.

An outside observer thus does not see a dark area in the region of the lighting modules when at least one of the lighting modules is deactivated, as is generally the case during the day. The invention thus makes it possible to harmonize the signature of the luminous device comprising a luminous module 600 arranged on a plurality of lighting modules, by using a single light guide 605, and making it possible to selectively illuminate the first and second patterns 650.1 and 650.2.

The luminous module 600 may for example be used in the example in FIG. 3, being arranged facing the lighting modules 301.1 and 301.2.

A single luminous module 600 may thus be advantageously used in a luminous device comprising a plurality of lighting modules. When the lighting modules have optical projection surfaces of different shapes, the first and second patterns 650.1 and 650.2 have different shapes so that they are identical to the respective optical surfaces of the lighting modules that they cover. This makes it possible to harmonize complex signatures between the periods of day and night.

Advantageously, the light sources 630.1 and 630.2 are controlled by the control element 340 described above. The control element 340 may also control the lighting modules facing which the luminous module 600 is placed. The control element 340 is thus capable of selectively activating the light sources 630.1 and 630.2 when it deactivates at least one of the lighting modules of the luminous device.

In the example in FIG. 3, the control element 340 activates the light source 630.1 so as to emit light in the first luminous pattern 650.1 arranged facing the first lighting module 301.1, when the first lighting module 301.1 is deactivated, and activates the light source 630.2 so as to emit light in the second luminous pattern 650.2 arranged facing the second lighting module 301.2, when the second lighting module 301.2 is deactivated.

In the first, second, third, and fourth embodiments described above, the pattern(s) of the luminous module 100, 200 may be controlled as a function of the activation of one of the signaling modules. The control element 340 may in particular control the luminous module(s) 100, 200, the lighting module(s), and also one or more signaling modules, such as those shown in FIG. 3. In particular, the control element 340 may advantageously activate the light source(s) of the luminous module 100, 200 when the daytime running light DRL signaling function is activated on at least one of the signaling modules responsible for this signaling function. Since such a function is activated during the day, it is thus ensured that the light sources of the luminous modules are activated during the day, which makes it possible to harmonize the signature of the luminous device 300 between situations of driving during the day and driving at night.

What is claimed is:

1. A luminous device for an automotive vehicle, comprising at least one lighting module capable of projecting light rays in order to perform a lighting function, a luminous module, and a control element;
wherein the luminous module is at least partially transparent and is arranged so that light rays emitted by the lighting module pass through it, and wherein the control element is capable of activating the luminous module when the at least one lighting module is deactivated.

2. The luminous device as claimed in claim 1, wherein the at least one lighting module is capable of performing a low beam lighting function and/or a high beam lighting function.

3. The luminous device as claimed in claim 2, further comprising a first lighting module capable of performing a low beam lighting function and a second lighting module capable of performing a high beam lighting function, the luminous module being arranged so that the light rays from the first lighting module and/or the second lighting module pass through it.

4. The luminous device as claimed in claim 1, wherein the luminous module is capable of emitting light rays in at least one luminous pattern, the luminous module being arranged so that the at least one luminous pattern is facing an optical surface of the at least one lighting module.

5. The luminous device as claimed in claim 1, wherein the luminous module is arranged inside a lens of an optical system of the at least one lighting module.

6. The luminous device as claimed in claim 1, wherein the luminous module is arranged on an outer lens of the luminous device.

7. The luminous device as claimed in claim 1, wherein the luminous module includes:
a light guide including an at least partially transparent guide sheet, the guide sheet being capable of receiving light rays through at least one light injection edge of the guide sheet and reflecting the light rays in a direction locally substantially normal to a surface of the guide sheet in at least one luminous pattern, at least one light injection element capable of receiving light and distributing the light in the guide sheet;
at least one light source capable of injecting light into the at least one light injection element;
wherein the control element is capable of activating the at least one light source when the at least one lighting module is deactivated.

8. The luminous device as claimed in claim 1, further comprising a first lighting module capable of performing a low beam lighting function and a second lighting module capable of performing a high beam lighting function, wherein the luminous module includes a single light guide, a first pattern being etched into a first part of the guide sheet of the single light guide and a second pattern being etched into a second part of the guide sheet of the single light guide, wherein the first pattern is arranged facing a first optical projection surface of the first lighting module and the second pattern is arranged facing a second optical projection surface of the second lighting module.

9. The luminous device as claimed in claim 1, wherein the luminous module includes an at least partially transparent substrate, an emission layer including an electroluminescent material contained between a first electrode and a second electrode, the first electrode being contained between the substrate layer and the emission layer, wherein the control element is capable of controlling a voltage source capable of applying a voltage between the first electrode and the second electrode, so that the emission layer emits light rays toward the outside of the luminous module.

10. The luminous device as claimed in claim 9, wherein the first electrode, the second electrode and the emission layer each have a thickness of less than 10 micrometers, in particular less than one micrometer.

11. The luminous device as claimed in claim 9, wherein the luminous module includes an at least partially transparent protective layer, for example made from glass, the second electrode being contained between the protective layer and the emission layer.

12. The luminous device as claimed in claim 9, wherein the electroluminescent material is an inorganic electroluminescent material, in particular an inorganic electroluminescent material comprising manganese-doped zinc sulfide.

13. The luminous device as claimed in claim 9, wherein the electroluminescent material is an organic electroluminescent material, in particular an electroluminescent organic polymer.

14. The luminous device as claimed in claim 9, wherein the first electrode, the second electrode and the emission layer each have a thickness of less than one micrometer.
